(19) United States
(12) Patent Application Publication
(10) Pub. No.: US 2016/0026244 A1
(43) Pub. Date: Jan. 28, 2016

(54) GUI DEVICE

(71) Applicant: SEIKO EPSON CORPORATION, Tokyo (JP)

(72) Inventors: Tomohiro OGAWA, Shiojiri-shi (JP); Toshifumi SAKAI, Shiojiri-shi (JP)

(21) Appl. No.: 14/795,492

(22) Filed: Jul. 9, 2015

(30) Foreign Application Priority Data
Jul. 24, 2014 (JP) 2014-150487

(51) Int. Cl. G06F 3/01; G06F 3/0484; G06F 3/0488; H04N 9/31

(52) U.S. Cl. CPC G06F 3/013; G06F 3/017; H04N 9/31; G06F 3/04842; G06F 3/04883

(57) ABSTRACT

A GUI (Graphical User Interface) device includes a projection unit that projects an image on a plurality of aerial screens overlapped in a predetermined gaze direction, a detection unit that detects a position of an instruction unit in an aerial region, and a selection unit that selects any one of the plurality of aerial screens as an operation object according to a motion of the detected instruction unit.

### CROSS REFERENCES TO RELATED APPLICATIONS

This application claims the benefit of Japanese Patent Application No. 2014-150487, filed on Jul. 24, 2014, which application is incorporated by reference herein.

### BACKGROUND

1. Technical Field

Embodiments of the present invention relate to a GUI (Graphical User Interface) device.

2. Related Art

A touch panel display has been used in a GUI of an electronic device. In addition, a technology in which a GUI image is displayed in an aerial region as disclosed in JP-A-2010-78623 and a technology in which an operation with respect to a virtual operation surface set in the aerial region is detected as disclosed in JP-A-2013-171529 have been developed.

The GUI device of the related art that displays the GUI image in the aerial region cannot be said to be good to use.

### SUMMARY

An advantage of some aspects of the invention is to provide a GUI (Graphical User Interface) device that displays a GUI image in an aerial region. The GUI device and GUI image are capable of being conveniently used by a user.

(1) According to an aspect of the invention, a GUI device includes a projection unit that projects an image on a plurality of aerial screens that are overlapped in a predetermined gaze direction, a detection unit that detects a position of an instruction unit in an aerial region, and a selection unit that selects any one of the plurality of aerial screens as an operation object with respect to a motion of the detected instruction unit.

In one example, the user can select a desired aerial screen by moving the instruction unit such as a finger in the gaze direction. For example, by moving the finger in the gaze direction, a front or back aerial screen further than the currently selected aerial screen can be selected. Here, the aerial screen is a region of a plane or a curved surface in the aerial region to which the projection unit projects the image. In addition, the gaze direction of the user is a direction assumed in advance according to a state or location of the GUI device. In addition, when the aerial screen is selected as an operation object, the image projected to the aerial screen, an object included in the image, and a process corresponding to the object are selected.

(2 and 3) In an example of the GUI device, the projection unit may highlight the image that is projected to the aerial screen and that is selected as the operation object. Specifically, the projection unit may highlight the image projected to the selected aerial screen as the operation object by adjusting at least any one of transmittance, sharpness, brightness, and chroma.

By adopting such a configuration, the aerial screen that is selected is easily recognized.

(4) In an example of the GUI device, the selection unit selects the aerial screen as the operation object when a position of the instruction unit in the gaze direction is in a predetermined range based on a position in the gaze direction of any one of the aerial screens. The predetermined range may be smaller than an interval between a plurality of the aerial screens in the gaze direction.

By adopting such a configuration, the aerial screen is easily selected.

In addition, embodiments of the invention may be realized by the GUI system configured to have a plurality of devices, and can be considered as an operation method of the GUI system configured to have one or more devices or as a program that operates the GUI system configured to have one or more devices.

### BRIEF DESCRIPTION OF THE DRAWINGS

Embodiments of the invention will be described with reference to the accompanying drawings, wherein like numbers reference like elements.

FIG. 1 is a block diagram illustrating a first embodiment of the invention.

FIGS. 2A and 2B are views of a configuration of screens illustrating the first embodiment of the invention.

FIG. 3 is a flow chart illustrating the first embodiment of the invention.

### DESCRIPTION OF EXEMPLARY EMBODIMENTS

Hereinafter, embodiments of the invention will be described with reference to drawings. In addition, configuration components corresponding to that of each drawing are given same numerals, and repeated descriptions thereof will be omitted.

### 1. Outline

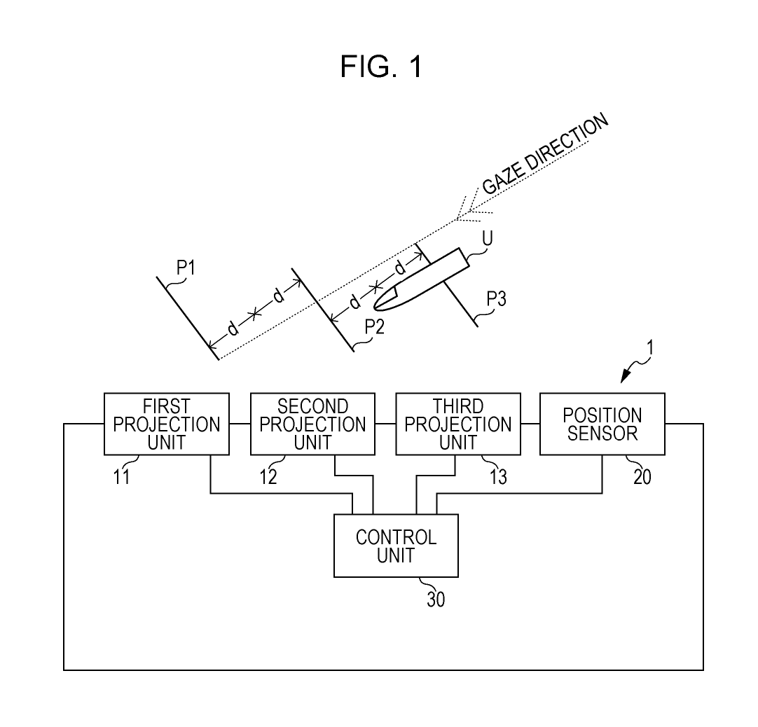

FIG. 1 illustrates a GUI (Graphical User Interface) device 1 as a first embodiment of the invention. The GUI device 1 may be an installation type device such as a printer, a scanner, or a fixed telephone. The GUI device 1 may be a portable type device such as a smart-phone, a tablet type personal computer (PC), a wrist watch type PC, or a glasses type PC. The GUI device 1 projects images including icons to a plurality of the aerial screens P1, P2, and P3. In one example, at least parts of the aerial screens P1, P2, and P3 overlap each other in a gaze direction of a user.

Each icon may correspond to a process. The user can make a process corresponding to each icon start by moving a tip of his or her finger U to a region of the icon projected to the aerial screens P1, P2, and P3. More specifically, the user can make a process associated with an icon start by moving his or her finger U to a region of the icon in one of the aerial screens. Even though the aerial screens P1, P2, and P3 overlap each other in the gaze direction, the GUI device 1 can determine and specify which icon is selected since the GUI device 1 detects a position of the finger U in the gaze direction. The GUI device 1 can further determine the aerial screen to which the icon belongs based on the position of the finger U in the gaze direction. In addition, the user can switch the aerial screen to another aerial screen by moving the tip of the finger U to a region where the icon in the aerial screen is not displayed. In other words, the user can switch aerial screens by moving the tip of the finger U to another region that does not correspond to the previously selected icon or aerial screen.

In order to realize these functions, the GUI device 1 includes a first projection unit 11, a second projection unit 12, a third projection unit 13, a position sensor 20, and a control unit 30.

### 2. Configuration

The first projection unit 11, the second projection unit 12, and the third projection unit 13 are devices that respectively project images to the aerial screens P1, P2, and P3. The aerial screens P1, P2, and P3 may be, in one example, a plane surface in the aerial region to which the first projection unit 11, the second projection unit 12, and the third projection unit 13 project the images. The aerial screens P1, P2, and P3 may respectively be a plane surface or a curved surface. A principle and a configuration of the device that displays the images in the aerial region are disclosed in JP-A-2003-233339, JP-A-2007-206588, and the like, and therefore, the description thereof will be omitted. These references are incorporated by reference in their entirety.

The position sensor 20 is a device that detects a position of the tip of the finger U in a three-dimensional region. The three-dimensional region includes, in one example, the aerial screens P1, P2, and P3. Because a principle and a configuration of a device that detects a position of an object having preset features in the three-dimensional region are well-known configurations, a description thereof will be omitted.

The control unit 30 may be a computer connected to the first projection unit 11, the second projection unit 12, the third projection unit 13, and the position sensor 20 and may include a program, a memory, and an input device and an output device (not illustrated). In the memory in the control unit 30, a GUI control program for controlling the position sensor 20, the first projection unit 11, the second projection unit 12, and the third projection unit 13 is stored.

### 3. Operation

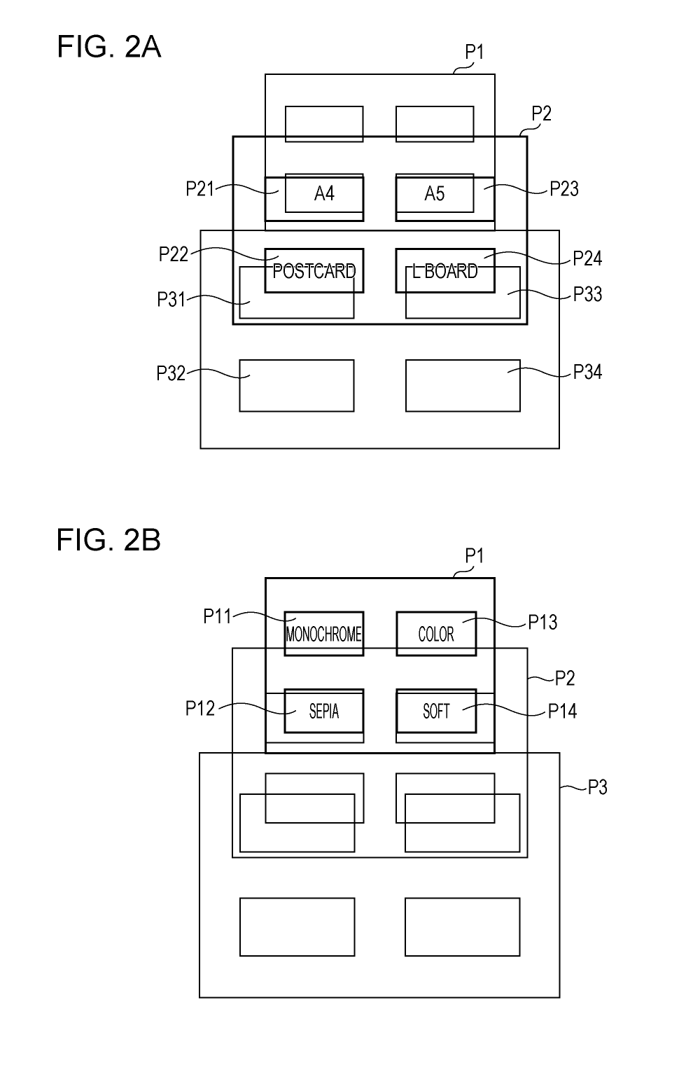

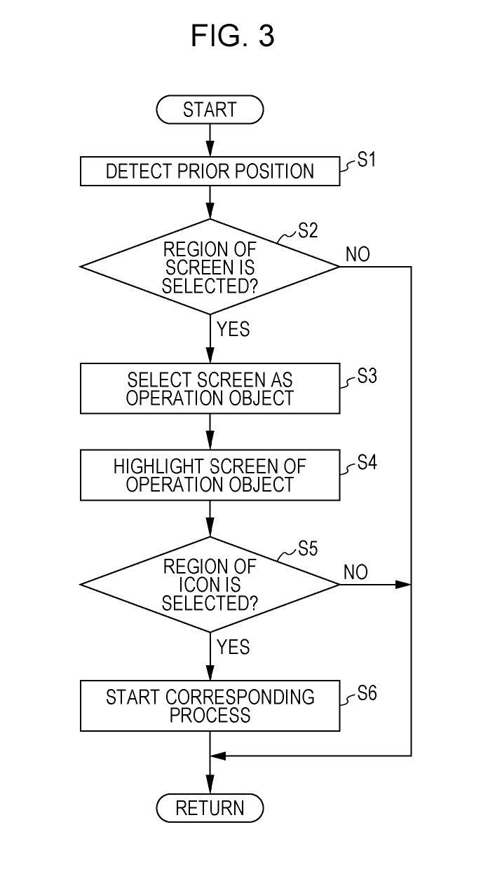

Next, an operation of the GUI device 1 will be described on the basis of FIGS. 2A to 3. FIGS. 2A and 2B illustrate the aerial screens P1, P2, and P3 when viewed in the gaze direction.

The first projection unit 11, the second projection unit 12, and the third projection unit 13 are capable of respectively displaying images on the aerial screens P1, P2, and P3 as illustrated in FIGS. 2A and 2B. FIGS. 2A and 2B illustrate a state in which the first projection unit 11 projects an image that includes icons P11, P12, P13, and P14 to the aerial screen P1, the second projection unit 12 projects an image that includes icons P21, P22, P23, and P24 to the aerial screen P2, and the third projection unit 13 projects an image that includes icons P31, P32, P33, and P34 to the aerial screen P3. In one embodiment, each of the icons in each or the aerial screens may be associated with a preset process. Thus, each preset process corresponds to a region where one of the icon images is formed.

The aerial screens P1, P2, and P3 are set or arranged so as to overlap with each other in the gaze direction of the user. The gaze direction of the user is a direction which may be assumed in advance according to a shape or position of the GUI device 1. The gaze direction may be assumed based on the position of the GUI device 1 and the expected position of a user. For example, in a printer, the gaze direction can be assumed on the basis of a position of a user's eye when the user is standing straight with respect to an outlet of a printed paper. In addition, in a glasses type PC, the gaze direction can be assumed on the basis of a front surface direction of the user's face when wearing the glasses type PC. The aerial screens P1, P2, and P3 may be set so that a part or the entirety thereof overlap with each other in the gaze direction of the user. In addition, the aerial screens P1, P2, and P3 may be set in the same region, the aerial screens P1, P2, and P3 may be set in a similar region, and the aerial screens P1, P2, and P3 may be set in a different region. In FIGS. 2A and 2B, in a case in which the aerial screens P1, P2, and P3 are set in the same region where a part thereof overlaps in the gaze direction of the user, the projected images observed by the user is illustrated. In FIGS. 2A and 2B, a reason that each size of the aerial screens P1, P2, and P3 is different is that the aerial screen in front of the user is large in an order of viewing by the user even though the aerial screens P1, P2, and P3 are in the same region.

The aerial screens P1, P2, and P3 are respectively set at a distance in a perpendicular direction thereof. The aerial screens P1, P2, and P3 may be separated in the predetermined region. The aerial screens P1, P2, and P3 may be set at equal intervals or at unequal intervals and may be set in parallel or in non-parallel with respect to each other. In one embodiment, regions of the aerial screens P1, P2, and P3 are set in parallel at equal intervals of a distance two ds (hereinafter, “two ds” is referred to as a “2d”) as illustrated in FIG. 1.

In order to improve a visibility of the aerial screens P1, P2, and P3, which may overlap with each other in the gaze direction of the user, the first projection unit 11, the second projection unit 12, and the third projection unit 13 highlight each image projected to the selected aerial screen. For example, because the first projection unit 11, the second projection unit 12, and the third projection unit 13 relatively lower a transmittance of the image projected to the selected the aerial screen and relatively raise a transmittance of the image projected to the non-selected aerial screen, the image on the selected aerial screen is more easily shown than on the other aerial screens. In other words, the visibility of the image on the selected aerial screen greater in part because of the change in the transmittance of the image in the selected aerial screen and/or the transmittances of the images in the non-selected aerial screens.

In addition, for example, because the first projection unit 11, the second projection unit 12, and the third projection unit 13 relatively raise the sharpness, the brightness, and the chroma of the image projected to the selected aerial screen and relatively lower the sharpness, the brightness, and the chroma of the image projected to the non-selected aerial screen, the image on the selected aerial screen is more easily shown than on the other aerial screens. The first projection unit 11, the second projection unit 12, and the third projection unit 13 may adjust any one of the transmittance, the sharpness, the brightness, and/or the chroma in order to highlight the image projected to the selected aerial screen or may adjust two or more among them (e.g., the sharpness, brightness, chroma), or all of them.

FIG. 3 is a flow chart illustrating an operation input process of the GUI device 1. After starting the GUI device 1, the operation input process illustrated in FIG. 3 is repeatedly performed at a short time interval, for example, in a degree in which a motion of the finger U is capable of being tracked with the accuracy of 1 mm or less.

First, the control unit 30 acquires a position of the tip of the finger U from the position sensor 20 (S1).

Next, the control unit 30 determines whether or not the tip of the finger U is in the selected region of the aerial screen (S2). The selected region of the aerial screen may be set by adding peripheral regions thereof to each region of the aerial screens. In one embodiment, in each of the aerial screens P1, P2, and P3 set at the distance 2d or separated by the distance 2d, when a distance from the screen in a vertical direction of the screen is less than a distance d, a region that coincides with the display region of the aerial screen in a direction parallel to the screen is referred to as a selected region. Because a region or portion of the distance 2d based on each aerial screen becomes the selected region, for example, in a case of in which the tip of the finger U is in a position illustrated in FIG. 1, the control unit 30 determines that the tip of the finger U is in the selected region of the aerial screen P2. In one example, the region that is less than a distance d from the screen may be part of the selected region. The selected region may be present on both sides of the aerial screen. The selected region may only be present on one side of the aerial screen. Thus, the dimensions of the selected region for both an icon and/or an aerial screen can vary or be changed.

In a case in which the tip of the finger U is not in the selected region of the aerial screen, the control unit 30 terminates the operation input process illustrated in FIG. 3. In a case in which the tip of the finger U is in any one of the selected regions of the aerial screens P1, P2, and P3, the control unit 30 selects the appropriate aerial screen as an operation object (S3). For example, in a case in which the tip of the finger U is in a position illustrated in FIG. 1, the aerial screen P2 is selected as the operation object.

When any one of the aerial screens is selected as the operation object, the first projection unit 11, the second projection unit 12, and the third projection unit 13 highlight the image projected to the aerial screen selected as the operation object (S4). Specifically, because the control unit 30 adjusts the transmittance, the sharpness, the brightness, the chroma, and the like of the image being output as a projection object to the first projection unit 11, the second projection unit 12, and the third projection unit 13, the image projected to the aerial screen which is selected as the operation object is highlighted. Specifically, with respect to the image on the aerial screen or aerial screens which are not the operation object, the transmittance thereof is raised, the sharpness thereof is lowered so as to blur the image, and/or the brightness and the chroma are compressed more than the image on the aerial screen which is the operation object.

Next, the control unit 30 determines whether or not the tip of the finger U is in a selected region of any one of icons projected to the selected aerial screen (S5). The selected region of the icon may be set by adding peripheral regions thereof to the display region of each icon. The selected region of the icon has, in one embodiment, a width equal to or less than the selected region of the aerial screen in the vertical direction of the screen, and the selected region of the icon is set so as to coincide with the display region of the icon in a direction parallel to the screen. When the selected region of the icon is set to be narrower than the selected region of the aerial screen in the gaze direction, the icon is not selected in a case in which the tip of the finger U is not moved further in the gaze direction after the aerial screen is selected. When the finger U is moved further in the gaze direction, the finger U may enter the selected region of the icon, which may result in selecting the region of the icon. Therefore, the user discriminates and easily performs a select operation of the aerial screen and a select operation of the icon.

When any one of the selected regions of the icons projected to the aerial screen is selected by the tip of the finger U, the control unit 30 starts the process corresponding to the icon (S6) and terminates the operation input process. When there is no selected region of the icons projected to the aerial screen when the aerial screen itself is selected, the control unit 30 terminates the operation input process without starting the process corresponding to the icon.

According to the embodiment described above, the user moves his or her finger U in the gaze direction so as to select the desired aerial screen. Because the selected region of the aerial screen is wider than a region of the aerial screen in the gaze direction, the user can easily select one of the aerial screens. In addition, because the image projected to the selected aerial screen is highlighted, the user can easily recognize which one of the aerial screens is selected.

### 4. Other Embodiment

A technical range of the invention is not limited to the embodiments described above and is capable of various changes in a range that does not departed from the spirit of the invention.

For example, in a case in which the tip of the finger is in any one of the selected regions of the aerial screens at a preset time or more, the GUI device may select the aerial screen. When the GUI device selects the aerial screen in such a case, the aerial screen is selected only in a case in which the user who wants to select the desired aerial screen places the tip of his or her finger on a region peripheral to the aerial screen. Accordingly, even though a separate aerial screen exists before (or in front of) the desired aerial screen, the user can select the desired aerial screen by moving his or her finger to penetrate the separate aerial screen. As the user's finger moves in the gaze direction, an aerial screen may be deselected when the tip is outside of the selected region and another aerial screen is selected when the tip of the finger enters the corresponding selected region.

In addition, for example, in a case in which the tip of the finger is in the selected region of the icon at the preset time or more, the GUI device may start the process corresponding to the icon. In a case in which the GUI device starts the process corresponding to the icon the process corresponding to the icon is started only in a case in which the user who wants to select the desired aerial screen places the tip of his or her finger on a region peripheral to the icon. A possibility that the icon is selected inappropriately is decreased even though the finger penetrates the icon part at the time of moving the finger on the screen. In a case in which the finger reciprocates between the selected region of the icon and the peripheral regions thereof, the process corresponding to the icon may be started.

In addition, for example, the GUI device highlights the image projected to the selected aerial screen by projecting the image to the foremost of the aerial screen when viewed from the gaze direction in one example. For example, in a case in which the aerial screen P1 illustrated in FIG. 1 is selected, the image projected to the aerial screen P1 may be displayed on the aerial screen P3, the image projected to the aerial screen P3 may be projected to the aerial screen P2, and the image projected to the aerial screen P2 may be projected to the aerial screen P1. Further, in a case in which the projected image is switched by selecting the aerial screen P3 as described above, the aerial screen P1 to which the image projected to the aerial screen P3 is newly projected automatically is selected, and a selected state of the aerial screen P1 may be maintained until the icon is selected or other aerial screens are selected.

In addition, for example, in a case in which the tip of the finger is moved quickly by a predetermined distance or more in the gaze direction, the GUI device may select the preset the aerial screen. Specifically, when detecting a case in which the tip of the finger U is moved within 0.5 seconds in the gaze direction by the distance 2d or more in FIG. 1, regardless of the position of the tip of the finger, the innermost aerial screen P1 may be selected when viewed from the gaze direction. On the other hand, when detecting a case in which the tip of the finger U is moved within 0.5 seconds in a direction opposite to the gaze direction by the distance 2d or more, regardless of the position of the tip of the finger, the foremost aerial screen P3 may be selected when viewed from the gaze direction.

In addition, in a case in which a preset motion of the tip of the finger is detected in one of the selected regions of the aerial screens, the GUI device may maintain the selected state of the aerial screen until a preset motion of the tip of the finger is detected. Specifically, when detecting a case in which the tip of the finger in the selected region of the aerial screen P2 reciprocates parallel to the aerial screen P2, regardless of the position of the tip of the finger, the selected state of the aerial screen P2 may be maintained until the motion of the tip of the same finger is detected in the selected region of the aerial screen P1 or the aerial screen P3.

In addition, for example, in a case in which the tip of the finger is moved toward the icon or is moved in a gaze depth direction with respect to the screen in the selected region of the icon, the GUI device may start the process corresponding to the icon.

In addition, for example, in the GUI device, a region wider than the aerial screen or the icon in a direction parallel to the screen may be considered as the selected region of the aerial screen or the selected region of the icon. Further, a width (depth) of the selected region in a gaze front direction and a width (depth) of the selected region in a gaze depth direction with respect to the screen may be different. Particularly, it is preferable that the width (depth) in a gaze front direction becomes larger than the width (depth) in a gaze depth direction in the selected region of the icon.

In addition, for example, the GUI device may receive a so called drag operation or a drag and drop operation. Specifically, in a case in which the tip of the finger is moved along the screen in the operation region in the selected region of one aerial screen, it may be assumed that the drag operation is performed. In a case in which the tip of the finger is departed from the operation region, the drag operation is terminated, and the drop operation is performed. Such a selected region is the same as or smaller than the selected region of the aerial screen; however, a distance from the aerial screen is desirably the same as the selected region of the icon. Consequently, the user can feel the same operation sensation as in a case in which the selected aerial screen is a general two-dimension touch panel display.

In addition, for example, the instruction unit as a subject for detecting the operation is not limited to the tip of the finger, but may also be a pencil, a pen, a tip of a stick, or the like. In addition, the instruction unit and the detection unit may include a communication function using infrared rays, or the like so that a position of the instruction unit is detected.

In addition, for example, the instruction unit is may include a plurality of instruction units. Multiple instruction units may be used at the same time. In this case, the aerial screen may be selected by the instruction unit with the highest priority among a plurality of the instruction units. The priority may be preset in each instruction unit, such as a forefinger of a hand used is given the high priority, or the priority may be raised in an order of inserting to a specific region of a region including all of the selected regions of the aerial screens, or the like.

In addition, for example, the number of the aerial screens may be two or more, or may be four or more. The number of the icons arranged in the image to be projected may be one, two, three, or more. The image to be projected itself may be a selecting object without arranging the icon in the image to be projected. Specifically, a photographic image is respectively projected to the plurality of the aerial screens, and the photographic image projected to the selected aerial screen may be projected to the aerial screen which is foremost in the gaze direction.

What is claimed is:

1. A GUI (Graphical User Interface) device comprising:
a projection unit that projects an image on each of a plurality of aerial screens that are overlapped in a predetermined gaze direction;
a detection unit that detects a position of an instruction unit in an aerial region; and
a selection unit that selects any one of the plurality of aerial screens as an operation object according to a motion of the detected instruction unit.

2. The GUI device according to claim 1,
wherein the selection unit selects any one of the plurality of aerial screens as the operation object according to a motion in a vertical direction of the aerial screen or a motion in a gaze direction of the detected instruction unit.

3. The GUI device according to claim 1,
wherein the projection unit highlights the image projected on the aerial screen which is selected as the operation object more than the image projected on the aerial screen which is not selected as the operation object.

4. The GUI device according to claim 3,
wherein the projection unit adjusts at least any one of transmittance, sharpness, brightness, and chroma so as to highlight the image projected on the aerial screen selected as the operation object.

5. The GUI device according to claim 1,
wherein, in a case in which the position of the instruction unit in the gaze direction is in a predetermined range based on the position of any one of the plurality of aerial screens in the gaze direction, the selection unit selects the aerial screen as an operation object, and
wherein the predetermined range is smaller than an interval between the plurality of the aerial screens in the gaze direction.

6. The GUI device according to claim 1,
wherein, in a case in which the position of the instruction unit of the aerial screen in the vertical direction is in a predetermined range based on the position of any one of the plurality of aerial screens in the gaze direction, the selection unit selects the aerial screen as an operation object, and
wherein the predetermined range is smaller than an interval between the plurality of the aerial screens in the vertical direction.

7. A recording medium of a program which controls
a GUI system including a projection unit that projects an image in an aerial region, and a detection unit that detects a position of an instruction unit in the aerial region,
wherein the projection unit projects the image to a plurality of aerial screens overlapped each other in a predetermined gaze direction, and
wherein the GUI system selects any one of the plurality of aerial screens as an operation object according to the motion of the instruction unit detected by the detection unit.
